(19) United States
(12) Patent Application Publication
(10) Pub. No.: US 2008/0024853 A1
(43) Pub. Date: Jan. 31, 2008

(54) LIGHT SOURCE DEVICE AND PROJECTOR

(75) Inventors: Kazuhiro TANAKA, Azumino-shi (JP); Tomiyoshi USHIYAMA, Minowa-machi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/776,133

(22) Filed: Jul. 11, 2007

(30) Foreign Application Priority Data
Jul. 27, 2006 (JP) 2006-204730

(51) Int. Cl. G02F 1/01; G05F 1/10

(52) U.S. Cl. 359/238; 315/291

(57) ABSTRACT

A light source device includes a high-pressure discharge lamp for performing electric discharge emission between a pair of electrodes, a lighting device for lighting the high-pressure discharge lamp by supplying a driving current of a predetermined frequency to the high-pressure discharge lamp, and a control device for controlling the lighting device, wherein the control device controls the frequency of the driving current supplied to the high-pressure discharge lamp from the lighting device and includes a frequency variance controlling section which supplies a low-frequency driving current having a low frequency and two or more types of high-frequency driving currents having frequencies higher than the low frequency to the high-pressure discharge lamp.

### BACKGROUND

1. Technical Field

The present invention relates to a light source device and a projector.

2. Related Art

In related art, a light source having a high-pressure discharge lamp which performs electric discharge between a pair of electrodes, a lighting device which lights the high-pressure discharge lamp by supplying a driving current (alternating current) to the high-pressure discharge lamp, and a control device which controls the lighting device is known.

In the light source device, when the high-pressure discharge lamp is lighted/driven by a driving current having a relatively low frequency (for example, less than 60 Hz), a protrusion (hereinafter, referred to as a first protrusion) which becomes a starting point for discharge is formed in the front ends of the electrodes of the high-pressure discharge lamp. According to this type of lighting/driving, the abrasion of the front ends of the electrodes of the high-pressure discharge lamp can be prevented and the durability of the high-pressure discharge lamp can be improved.

However, in this type of lighting/driving of the high-pressure discharge lamp, the temperatures of the electrodes of the high-pressure discharge lamp become relatively low and, although the first protrusion is formed, the position of the arc is moved and thus the arc cannot be stabilized, and accordingly, there is a problem of so-called flickering.

In order to prevent the flickering, a technology in which a high-frequency rectangular waveform current is applied for one period right after the half period of a low-frequency rectangular waveform current (for example, see JP-A-2001-244088) has been proposed. In other words, in the technology disclosed in JP-A-2001-244088, the decrease in the temperatures of the electrodes and the flickering are suppressed by applying a high-frequency rectangular waveform current for one period right after the half period of a low-frequency rectangular waveform current.

However, in the technology disclosed in JP-A-2001-244088, in order to avoid the decrease in the temperatures of the electrodes, the frequency of the low-frequency rectangular waveform current is required to be set in the range of 60 Hz to 500 Hz, although the high-frequency rectangular waveform current is applied for one period, thus the frequency of the low-frequency rectangular waveform current can be set to a relatively low value. In other words, in the technology disclosed in JP-A-2001-2440838, a low-frequency rectangular waveform current having a relatively high frequency and a high-frequency rectangular waveform current are supplied to the high-pressure discharge lamp and the front end of the electrode becomes worn, and accordingly the durability of the high-pressure discharge lamp cannot be improved.

In addition, when the frequency of the driving current supplied to the high-pressure discharge lamp is relatively high, the temperature distribution of the electrode surfaces becomes uniform. When the temperature distribution of the electrode surfaces become uniform as described above, an unnecessary protrusion (hereinafter, referred to as a second protrusion) different from the first protrusion may be easily formed in the electrode. In a case where the second protrusion is formed in the electrode, the starting point of the arc is moved to the first or second protrusion and the flickering occurs.

In other words, in the technology disclosed in JP-A-2001-244088, since a low frequency rectangular waveform current having a relatively high frequency and a high-frequency rectangular waveform current are provided to the high-pressure discharge lamp, the temperature distribution of the electrode surfaces becomes uniform and the second protrusion may be easily formed, consequently the flickering occurs.

Accordingly, a technology capable of improving the durability of the high-pressure discharge lamp and suppressing the flickering is desired.

### SUMMARY

An advantage of some aspects of the invention is to provide a light source device and a projector which are capable of improving the durability of a high-pressure discharge lamp and suppressing flickering.

A light source device according to an aspect of the invention includes a high-pressure discharge lamp for performing electric discharge emission between a pair of electrodes, a lighting device for lighting the high-pressure discharge lamp by supplying a driving current of a predetermined frequency to the high-pressure discharge lamp, and a control device for controlling the lighting device. Here, the control device controls the frequency of the driving current supplied to the high-pressure discharge lamp from the lighting device and includes a frequency variance controlling section which supplies a low-frequency driving current having a low frequency and two or more types of high-frequency driving currents having frequencies higher than the low frequency to the high-pressure discharge lamp.

According to the aspect of the invention, since the frequency variance controlling section drives/controls the lighting device and supplies two or more types of high-frequency driving currents other than the low-frequency driving current from the lighting device to the high-pressure discharge lamp, the decrease in the temperatures of the electrodes and flickering can be suppressed.

In addition, since the temperatures of the electrodes can be made to be sufficiently high by supplying two or more types of high-frequency driving currents to the high-pressure discharge lamp, it becomes possible to set the low-frequency driving current to a sufficiently low frequency. Accordingly, the driving current having a sufficiently low frequency is supplied to the high-pressure discharge lamp, whereby the abrasion of the front end of the electrode of the high-pressure discharge lamp can be prevented and the durability of the high-pressure discharge lamp can be improved.

It is preferable that the frequency variance controlling section of the light source device supplies the low-frequency driving current and the two or more nigh-frequency driving currents to the high-pressure discharge lamp at predetermined time intervals.

In this case, since the frequency variance controlling section supplies the low-frequency driving currents the two or more high-frequency driving currents to the high-pressure discharge lamp at predetermined time intervals, the temperatures of the electrodes of the high-pressure discharge lamp can be changed by time. Accordingly, the uniformization of the temperature distribution of the electrode surfaces can be prevented and the formation of the unnecessary second protrusion in the electrode can be suppressed by changing the temperatures of the electrodes of the high-pressure discharge lamp by time. Consequently, the advantages of improving the durability of the high-pressure discharge lamp and suppressing the flickering can be achieved appropriately.

It is preferable that the frequency variance controlling section supplies a driving current having a first high-frequency to the high-pressure discharge lamp right before the polarity inversion of a waveform of the low frequency driving current at each half period of the waveform of the low frequency driving current and supplies a driving current having a second high-frequency higher than the first high-frequency to the high-pressure discharge lamp.

When a high-pressure discharge lamp is driven by an alternating current (driving current), a pair of electrodes of the high-pressure discharge lamp serves as a negative electrode during one half period of the driving current and serves as a positive electrode during the other half period. In other words, the electrode is in a negative electrode phase or in a positive electrode phase during each half of a period. The electrode material which is removed from the positive electrode in the positive electrode phase is returned in a flow of ions to the electrode in the negative electrode phase. The transfer processes determine the temperatures of the electrodes during one period of the driving current. The reason is that the dependence of the temperatures of the electrodes in the positive electrode phase is different from that in the negative electrode phase. Thus, the temperatures of the electrodes are changed markedly over the whole period of the driving current, and arcs are generated from several spots on the surfaces of the electrodes in the positive electrode phase. On the other hand, the generation of an arc is limited to only one of the several spots on the surfaces of the same electrodes in the negative electrode phase. In other words, there is a difference between the temperatures of the electrodes during the positive electrode phase and the negative electrode phase, and the pair of the electrodes are respectively in the positive and negative electrode phases during the one half period of the driving current and are respectively in the negative and positive electrode phases during the other half period of the driving current, and accordingly, the fluctuation of the arc can easily occur after the inversion of the polarity.

In this case, since the frequency variance controlling section supplies the first high-frequency driving current and the second high-frequency driving current to the high-pressure discharge lamp right before the polarity inversion of a waveform of the low frequency driving current at each half period of the waveform of the low frequency driving current, the temperatures of the pair of electrodes can be uniformized at one moment right before the inversion of the polarity, and the fluctuation of the arc after the inversion of the polarity can be suppressed. Consequently, the advantages of improving the durability of the light source lamp and suppressing the flickering can be achieved appropriately.

It is preferable that the control device of the light source device controls the driving current supplied from the lighting device to the high-pressure discharge lamp and includes a current variance controlling section which increases peak values of the waveforms of the two or more types of high-frequency driving currents to be larger than the peak value of the waveform of the low-frequency driving current.

In this case, since the current variance controlling section controls the driving of the lighting device and makes the peak values of the waveforms of the two or more types of high-frequency driving currents to be greater than the peak value of the waveform of the low frequency driving current, high currents can be supplied to the high-pressure discharge lamp as the two or more types of the high frequency driving currents and the decrease of the electrode temperature can be suppressed. Further, by making the peak values of the waveforms of the two or more types of high frequency driving currents greater than the peak value of the waveform of the low frequency driving current, the temperatures of the electrodes can be made to be sufficiently high, whereby low-frequency driving current can have a sufficiently low frequency. Consequently, the advantages of improving the durability of the high-pressure discharge lamp and suppressing the flickering can be achieved more appropriately.

It is preferable that the low frequency in the light source device is less than 60 Hz.

In this case, since the low frequency is less than 60 Hz, the advantages of improving the durability of the high-pressure discharge lamp and suppression of the flickering can be achieved more appropriately, while it is difficult to improve the durability of the high-pressure discharge lamp and suppress the flickering, for example, when the low frequency is equal to or higher than 60 Hz.

A projector according to another aspect of the invention includes a light source device, an optical modulation device for forming an optical image by modulating a light beam emitted from the light source device in accordance with image information, and a projection optical device projecting the optical image formed by the optical modulation device on an enlarged scale. The light source device is the light source device described above.

According to the aspect of the invention, since the projector has the above-described light source device, the same advantages as in the light source device can be acquired.

In addition, since the projector has a light source device that can improve the durability of the high-pressure discharge lamp, the durability of the projector can be improved.

In addition, since the projector has a light source device that can suppress the flickering, an excellent projection image without any flicker can be formed.

### BRIEF DESCRIPTION OF THE DRAWINGS

The invention will be described with reference to the accompanying drawings wherein like numbers reference like elements.

FIG. 1 is a diagram showing a schematic configuration of a projector according to a first embodiment of the invention.

FIG. 2 is a block diagram showing a schematic configuration of a light source device according to the first embodiment.

FIG. 3 is a schematic diagram showing a waveform of a driving current which is supplied to the light source lamp from a lighting device according to the first embodiment.

FIG. 4 is a schematic diagram showing a waveform of a driving current supplied from a lighting device to a light source lamp according to a second embodiment of the invention.

FIG. 5 is a diagram showing a modified example of the embodiments.

FIG. 6 is a diagram showing a modified example of the embodiments.

FIG. 7 is a diagram showing a modified example of the embodiments.

FIG. 8 is a diagram showing a modified example of the embodiments.

FIG. 9 is a diagram showing a modified example of the embodiments.

### DESCRIPTION OF EXEMPLARY EMBODIMENTS

### First Embodiment

Hereinafter, a first embodiment of the present invention will be described with reference to accompanying drawings.

### Schematic Configuration of Projector

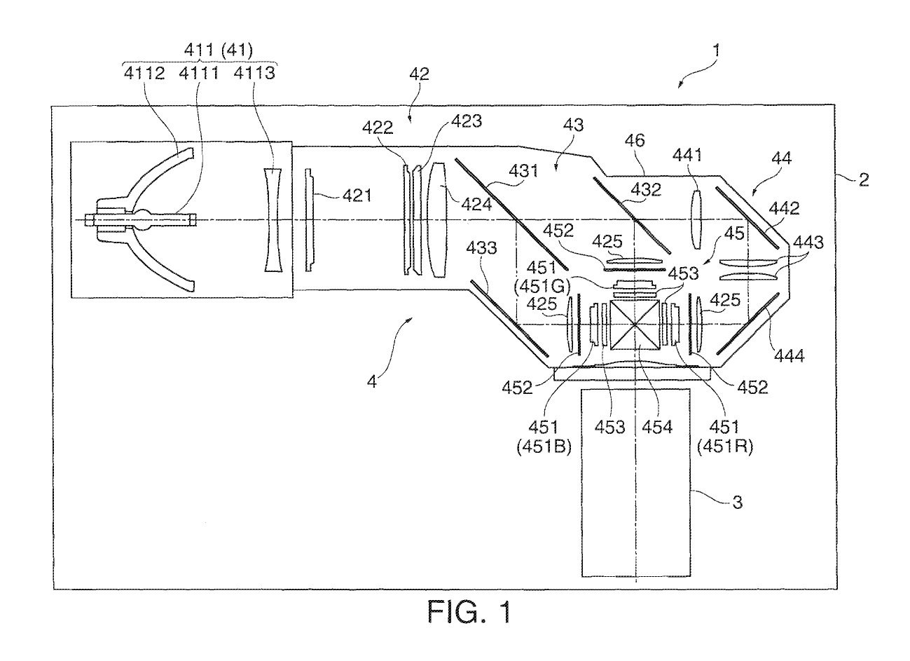

FIG. 1 is a diagram showing a schematic configuration of a projector 1.

The projector 1 modulates a light beam emitted from a light source in accordance with image information to form a color image (optical image) and projects the color image on a screen (not shown in the figure) on an enlarged scale. The projector 1, as shown in FIG. 1, includes an external case 2 in the form of an about rectangular parallelepiped, a projection lens 3 as a projection optical device, and an optical unit 4.

In FIG. 1, although detailed drawing is omitted, a refrigeration unit which refrigerates the inside of the projector 1, a power unit which supplies electric power to constituent members inside the projector 1, a control substrate which controls the configuration members inside the projector 1, and the like are disposed in a space inside the external case 2 not occupied by the projection lens 3 and the optical unit 4.

The projection lens 3 includes a set of lenses formed by housing a plurality of lenses in a lens tube that is fin the shape of a tube. The projection lens projects a color image formed by the optical unit 4 on a screen on an enlarged scale.

### DETAILED DESCRIPTION OF OPTICAL UNIT

The optical unit 4, as shown in FIG. 1, extends to be protruded along a bottom side of the external case 2 together with being protruded along the side of the external case 2 and has a form of an about “L” in a plane. The optical unit forms a color image in accordance with image information by optically processing the light beam emitted from the light source under the control of the control substrate. The optical unit 4, as shown in FIG. 1, includes a light source device 41, an integrator illuminating optical device 42, a color separation optical device 43, and a relay optical device 44, an optical device 45, and an optical component case 46.

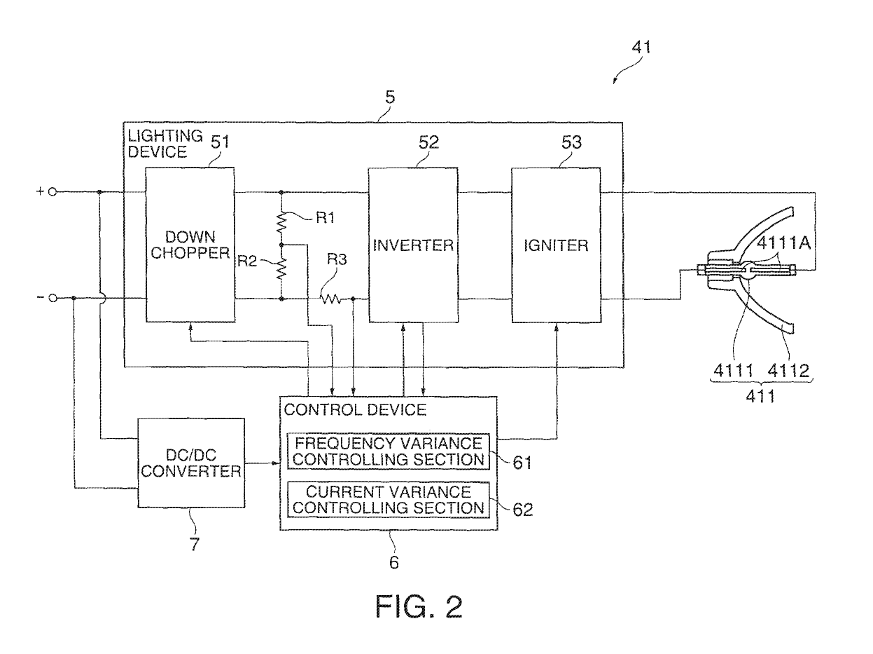

The light source device 41 emits light beam toward the integrator illuminating optical device 42. The light source device 41, to be described in detail later, includes a light source device main body 411, a lighting device 5 (see FIG. 2) which lights a light source lamp 4111 by supplying a driving current of a predetermined frequency to the light source lamp 4111 as a high-pressure discharge lamp constituting the light source device main body 411, and a control device 6 (see FIG. 2) which drives/controls the lighting device 5.

The light source device main body 411 includes the light source lamp 4111 performing electric discharge emission between a pair of electrodes 4111A (See FIG. 2), a main reflection mirror 4112, and a parallelization concave lens 4113.

The light beam radiated from the light source lamp 4111 are emitted as converging light with the direction of the emission adjusted to the front side of the light source device main body 411 by the main reflection mirror 4112. The emitted light beam are parallelized by the parallelization concave lens 4113 and emitted to the integrator illuminating optical device 42.

Here, as the light source lamp 4111, a halogen lamp, a metal halide lamp, or a high-pressure mercury lamp is generally used. As the main reflection mirror 4112, an elliptic reflector is used in FIG. 1, but parabolic reflector which substantially parallelizes the light beam emitted from the light source lamp 4111 for reflecting may be used. In this case, the parallelization concave lens 4113 is omitted.

The integrator illuminating optical device 42 is an optical system for substantially uniformly emitting the light beam emitted from the light source device main body 411 to an image forming region of a liquid crystal panel, to be described later constituting the optical device 45. The integrator illuminating optical device 42, as shown in FIG. 1, includes a first lens array 421, a second lens array 422, a polarization conversion element 423, and a superposing lens 424. The first lens array 421 has a configuration in which first small lenses having substantially rectangular contours viewed from an axial direction of incident light are arranged in the shape of a matrix within a face substantially perpendicular to the axis of the incident light. Each of the first small lenses divides the light beam emitted from the light source device main body 411 into a plurality of partial light beams.

The second lens array 422 has a configuration similar to the first lens array 421 and has a configuration in which second small lenses are arranged in the shape of a matrix. The second lens array 422 together with the superposing lens 424 forms images of the first small lenses of the first lens array 421 on a liquid crystal panel, to be described later, of the optical device 45.

The polarization conversion element 423 is disposed between the second lens array 422 and the superposing lens 424. The polarization conversion element 423 converts the light transmitted from the second lens array 422 into substantially one type of polarized light beam.

To be more specific, partial light beams which have been converted into substantially one type of polarized light beam by the polarization conversion element 423 are substantially superposed on the liquid crystal panel, to be described later, of the optical device 45 in the end by the superposing lens 424. Since only one type of polarized light beam can be used in the type of a liquid crystal panel in which a polarized light beam is modulated, about a half of the light transmitted from the light source device 41 which emits randomly polarized light beam cannot be used. Thus, the light emitted from the light source device 41 is converted into substantially one type of polarized light beam by using the polarization conversion element 423, thereby improving the usage efficiency of the light in the optical device 45.

The color separation optical device 43, as shown in FIG. 1, includes two dichroic mirrors 431 and 432 and a reflection mirror 433. The color separation optical device 43 divides a plurality of partial light beams emitted from the integrator illuminating optical device 42 into light beams of three colors including red, green, and blue colors by using the dichroic mirrors 431 and 432.

The relay optical device 44, as shown in FIG. 1, includes an incident side lens 441, a relay lens 443, and reflection mirrors 442 and 444. The relay optical device 44 guides a red light component which is separated from the color separation optical device 43 to a red light liquid crystal panel, to be described later, of the optical device 45.

At this time, a blue light component of the light beams emitted from the integrator illuminating optical device 42 is reflected by the dichroic mirror 431 of the color separation optical device 43, and the red light component and the green light component are transmitted through the dichroic mirror 431. The blue light component which is reelected by the dichroic mirror 431 is reflected by the reflection mirror 433, passes through a field lens 425, and reaches a blue light liquid crystal panel, to be described later, of the optical device 45.

The field lens 425 converts the partial light beams emitted from the second lens array 422 into light beams parallel to its center axis (main light beam). The field lenses 425 provided to the incident sides of the light beams of green and red light liquid crystal panels operate similarly.

Between the red and green light components which are transmitted through the dichroic mirror 431, the green light component is reflected by the dichroic mirror 432, passes through the field lens 425, and reaches a green light liquid crystal panel, to be described later, of the optical device 45. On the other hand, the red light component is transmitted through the dichroic mirror 432, passes through the relay optical device 44, passes through the field lens 425, and reaches a red light liquid crystal panel, to be described later, of the optical device 45.

The reason why the relay optical device 44 is used for the red light component is that the decrease in the usage efficiency of the light due to its divergence is prevented since the length of the light path of red light is greater than that of any other color light. In other words, the total partial light beams incident to the incident side lens 441 are transferred to the field lens 425.

The optical device 45, as shown in FIG. 1, includes three liquid crystal panels 451 (a red light liquid crystal panel is denoted by 451R, a green light liquid crystal panel is denoted by 451G, and a blue light liquid crystal panel is denoted by 451B) as an optical modulation device, an incident side polarizing plate 452 and an emitting side polarizing plate 453 which are respectively disposed in the light flux incident side and the light flux emitting side of the liquid crystal panels 451, and a cross dichroic prism 454.

The incident side polarizing plate 452 transmits only polarized light beam of the color light components separated by the color separation optical device 43 which has a substantially same polarized direction as a polarized direction which is adjusted by the polarization conversion element 423 and absorbs the other light beams. The incident side polarizing plate 452 has a structure in which a polarizing membrane is attached to a light-transmissive substrate, although the detailed structure thereof is omitted in the figure.

Each of the liquid crystal panels 451 has structure in which liquid crystals as electro-optical materials are sealed between one pair of transparent glass substrates. The liquid crystal panels 451 control the alignment status of the liquid crystals within an image forming region in response to image information and modulate the polarized direction of polarized light beam which are emitted from the incident side polarizing plate 452.

The emitting side polarizing plate 453 has a structure similar to the incident side polarizing plate 452. The emitting side polarizing plate 453 transmits only light beam emitted from the image forming region of the liquid crystal panel 451 and absorbs the other light beams.

The cross dichroic prism 454 forms a color image by composing modulated optical images for each color light component emitted from the emitting side polarizing plate 453. The cross dichroic prism 454 is formed by four rectangular prisms to be respectively in the shape of a square in a plane. On the boundary faces of the rectangular prisms, two dielectric multi-layered membranes are formed. The dielectric multi-layered membranes transmit the color light component which is emitted from the liquid crystal panel 451G through the emitting side polarizing plate 453 and reflect the color light components which are respectively emitted from the liquid crystal panels 451R and 451B through the emitting side polarizing plate 453. As described above, the color light components are composed to form a color image. The color image formed by the cross dichroic prism 454 is projected on a screen or the like by the above-described projection lens 3 on an enlarged scale.

### Configuration of Light Source Device

FIG. 2 is a block diagram showing a schematic configuration of the light source device 41.

The light source device 41, as shown in FIG. 2, includes a light source device main body 411, a lighting device 5, and a control device 6.

The lighting device 5 lights/drives the light source lamp 4111. The lighting device 5, as shown in FIG. 2, includes a down chopper 51, an inverter 52, and an igniter 53.

The down chopper 51 is connected to the power unit and receives a DC voltage as an input. The down chopper 51 drops the input voltage to an appropriate DC voltage and supplies the dropped voltage to the inverter 52. The down chopper 51, although detailed drawing thereof is omitted, has a configuration of a general chopper including a diode, a choke coil, a capacitor, and a switching element. The current (driving current) or power (driving power) supplied to the inverter 52 (light source lamp 4111) is controlled by adjusting the duty ratio (a ratio of an ON time per unit time and an OFF time per unit) of the switching element under the control of the control device 6. Resistors R1 and R2 are connected to an output terminal of the down chopper 51 in parallel, and a voltage of a connection node of the resistors R1 and R2 as an output voltage of the down chopper 51 is supplied to the control device 6. A resistor R3 is connected to a negative voltage side of the down chopper 51 in series, and a current flowing through the resistor R3 is detected as a driving current to be supplied to the control device 6.

The inverter 52 converts a DC current supplied from the down chopper 51 into an AC current of a predetermined frequency and supplies the AC current to the light source lamp 4111. The inverter 52, although detailed drawing thereof is omitted, has a configuration of a general full bridge circuit including full bridge-connected four switching elements. The frequency of the AC current (driving current) supplied to the light source lamp 4111 is controlled by adjusting the timing for turning each two switching elements ON/OFF by turns under the control of the control device 6.

The igniter 53 includes a boosting circuit that is not shown in the figure. The igniter 53 applies a pulse voltage having a high voltage level between the pair of electrodes 4111A under the control of the control device 6 at the time of starting driving of the light source lamp 4111 for breaking the insulation and forming a discharge path.

The control device 6, for example, includes a microprocessor and controls the driving of the lighting device 5 based on control program stored in memory that is not shown in the figure. The control device 6, as shown in FIG. 2, is connected to a DC/DC converter 7 and is operated based on a driving voltage generated by the DC/DC converter 7. The DC/DC converter 7 is connected to the power unit for receiving a DC voltage as an input, converts the input voltage into an appropriate DC voltage, and supplies the DC voltage to the control device 6.

The control device 6, as shown in FIG. 2, includes a frequency variance controlling section 61 and a current variance controlling section 62.

The frequency variance controlling section 61 adjusts the timing for turning each two switching elements of the inverter 52 ON/OFF by turns by outputting a predetermined driving signal to the inverter 52 in accordance with the control program and controls the frequency of the driving current supplied to the light source lamp 4111 from the lighting device 5. To be more specifically, the frequency variance controlling section 61 performs a frequency variance control so that a driving current having a low frequency, a driving current having a first high frequency which is higher than the low frequency, and a driving current having a second high frequency which is higher than the first high frequency are sequentially supplied to the light source lamp 4111 at predetermined time intervals from the lighting device 5.

In accordance with the control program, the current variance controlling section 62 outputs a predetermined driving signal to the down chopper 51 for adjusting the duty ratio of the switching element of the down chopper 51 and controls the driving current supplied to the light source lamp 4111 from the lighting device 5, while recognizing the voltage (output voltage of the down chopper 51) of the connection node of the resistors R1 and R2 and the current (driving current) flowing through resistor R3. To be more specifically, the current variance controlling section 62 performs a current variance control so that the peak value of the waveform of the driving current having the first high frequency is made to be greater than that of the driving current having the low frequency supplied from the lighting device 5 and the peak value of the waveform of the driving current having the second high frequency is made to be greater than that of the driving current having the first high frequency.

The control device 6 includes an external control interface for inputting a control signal from an external circuit, although detailed drawing thereof is omitted. The control device 6 is connected to the control substrate through the external control interface.

### Operation of Light Source Device

Next, the operation of the above-described light source device 41 will be described.

At first, a power-on signal is output from an operation panel to the control substrate in accordance with a user's operation for turning-on the power of the projector in the operation panel, which is not shown, of the projector 1. Then, the control substrate outputs a predetermined control signal to the control device 6 of the lighting device 41 in accordance with the power-on signal. The control device 6 outputs a driving signal to the lighting device 5 in response to the input of the control signal from the control substrate in accordance with the control program, so that the lighting device 5 is operated as described later, and whereby the lighting of the light source lamp 4111 is started.

The down chopper 51 drops the input DC voltage and supplies the dropped DC voltage to the inverter 52. The inverter 52 converts the input DC current into an AC current of a predetermined frequency and outputs the AC current to the igniter 53. The igniter 53 applies a pulse voltage having a high voltage level between the pair of the electrodes 4111A. The light source lamp 4111 starts lighting with the insulation between the pair of the electrodes 4111A being broken. After the lighting of the light source lamp 4111, the output voltage of the inverter 52 is directly applied to the light source lamp 4111 for maintaining the lighting status.

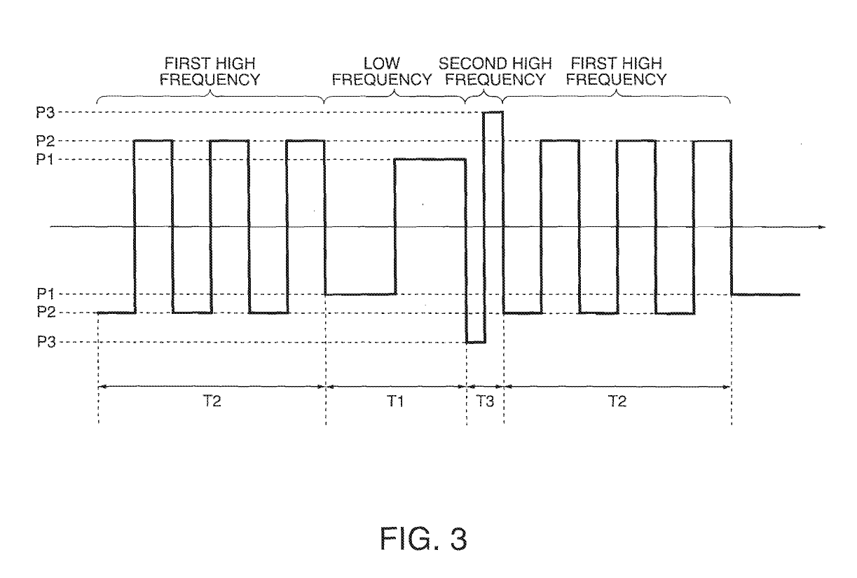

FIG. 3 is a schematic diagram showing a waveform of a driving current which is supplied to the light source lamp 4111 from the lighting device 5.

The control device 6 performs the frequency variance control and the current variance control by outputting a driving signal to the lighting device 5 in accordance with the control program after starting of lighting of the light source lamp 4111, so that the lighting device 5 is operated as below.

The inverter 52 adjusts the timing for turning each two switching elements ON/OFF by turns and sequentially changes the frequency of the driving current supplied to the light source lamp 4111 as shown in FIG. 3. To be more specific, the inverter 52, as shown in FIG. 3, at first, sets the frequency of the driving current supplied to the light source lamp 4111 to a first high frequency for a time period T2 (hereinafter, referred to as the first high-frequency period T2). In FIG. 3, the first high frequency period T2 is set to a period in which three periods of the first high-frequency are inserted. Next, the inverter 53, as shown in FIG. 3, sets the frequency of the driving current supplied to the light source lamp 4111 to the low frequency for a time period T1 (hereinafter, referred to as the low frequency period T1). In FIG. 3, the low frequency period T1 is set to a period in which one period of the low frequency is inserted. Next, the inverter 52, as shown in FIG. 3, sets the frequency of the driving current supplied to the light source lamp 4111 to the second high frequency for a time period T3 (hereinafter, referred to as the second high frequency period T3). In FIG. 3, the second high frequency period T3 is set to a period in which one period of the second high frequency is inserted. The frequency variance controlling section 61 of the control device 6 performs the frequency variance control by having the inverter 52 repeat the above-described operations.

In the embodiment, the low frequency is set to a frequency lower than 60 Hz. In addition, the first and second high frequencies are respectively set to a frequency 60 Hz or higher and a frequency equals to or lower than 500 Hz. The second high frequency is set to be higher than the first high frequency.

In the above-described operation, the duty ratio of the switching element is adjusted, and the down chopper 51, as shown in FIG. 3, changes the peak value of the driving current supplied to the light source lamp 4111 for each frequency (a low frequency, a first high frequency, and a second high frequency) of the driving current. To be more specifically, the down chopper 51, as shown in FIG. 3, at first, changes the peak value of the driving current supplied to the light source lamp 4111 to a peak value P2 for the first high frequency period T2. Next, the down chopper 51, as shown in FIG. 3, changes the peak value of the driving current supplied to the light source lamp 4111 to a peak value P1 for the low frequency period T1. Next, the down chopper 51, as shown in FIG. 3, changes the peak value of the driving current supplied to the light source lamp 4111 to a peak value P3 for the second high frequency period T3. The peak values P1 to P3, as shown in FIG. 3, are set to satisfy the relationship of “P1<P2<P3”. The current variance controlling section 62 of the control device 6 performs the current variance control in which the control device makes the down chopper 51 repeatedly perform the above-described operation.

In the first embodiment described above, there are following advantages.

In the embodiment, since the frequency variance controlling section 61 controls the driving of the lighting device 5 and supplies the driving currents of the first and second high frequencies to the light source lamp 4111 from the lighting device 5 along with the driving current of a low frequency, the decrease in the temperatures of the electrodes 4111A and the flickering can be suppressed. Accordingly, the projector 1 can form an excellent projection image without any flicker.

In addition, since the temperatures of the electrodes 4111A can be made to be sufficiently high by supplying driving currents of the first and second high-frequencies to the light source lamp 4111, it becomes possible to set the low-frequency driving current to a sufficiently low frequency (less than 60 Hz). Accordingly, the driving current having a sufficiently low frequency is supplied to the light source lamp 4111, whereby the abrasion of the front ends of the electrodes 4111 of the light source lamp 4111 can be prevented and the durability of the light source lamp 41111 can be improved. As a result, the durability of the projector 1 can be improved.

Here, since the frequency variance controlling section 61 respectively supplies the low-frequency driving current, the first high-frequency driving current, and the second high-frequency driving current to the light source lamp 4111 at each time intervals T1, T2, and T3, the temperatures of the electrodes 4111A of the light source lamp 4111 can be changed by time. Accordingly, the uniformization of the temperature distribution of the surfaces of the electrodes 4111A can be prevented and the formation of an unnecessary second protrusion the electrodes 4111A can be suppressed by changing the temperatures of the electrodes 4111A of the light source lamp 4111 by time. Consequently, the above-described advantages of improving the durability of the light source lame 4111 and suppressing the flickering can be achieved appropriately.

In addition, since the current variance controlling section 62 controls the driving of the lighting device 5 and controls such that the peak value P2 of the waveform of the driving current having the first high frequency is greater than the peak value P1 of the waveform of the driving current having the low frequency and the peak value P3 of the waveform of the driving current having the second high frequency is greater than the peak value P2 of the waveform of the driving current having the first high frequency, a high current flows for the time intervals T2 and T3, whereby the decrease in the temperatures of the electrodes 4111A can be further suppressed. In addition, since the temperatures of the electrodes 4111A can be made to be sufficiently high by having the peak values P2 and P3 of the waveforms of the first and second high-frequency driving currents to be greater than the peak value P1 of the waveform of the low-frequency driving current, the low-frequency (less than 60 Hz) driving current can have a sufficiently low frequency. Consequently, the above-described advantages of improving the durability of the light source lamp 4111 and suppressing the flickering can be achieved more appropriately.

### Second Embodiment

Next, a second embodiment of the invention will be described with reference to the accompanying drawings.

Hereinafter, to a same structure or member as that in the first embodiment, a same reference sign is attached and detailed description thereof is omitted or simplified.

In the first embodiment, the frequency variance controlling section 61 supplies driving currents of the low frequency, the first high-frequency, and the second high-frequency to the light source lamp 4111 respectively at time intervals T1, T2 and T3 in performing the frequency variance control.

On the other hand, in the second embodiment, the frequency variance controlling section 61 supplies the first high-frequency driving current and the second high-frequency driving current to the light source lamp 4111 right before the polarity inversion of a waveform of the low frequency driving current at each half period of the waveform of the low frequency driving current in performing the frequency variance control. In other words, only the function of the frequency variance controlling section 61 is different from that of the first embodiment and the other configurations are the same as those of the first embodiment.

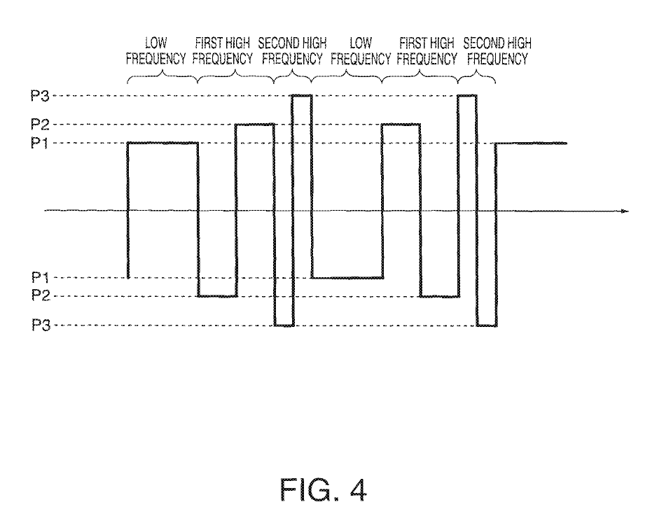

FIG. 4 is a schematic diagram showing a waveform of a driving current supplied from the lighting device 5 to the light source lamp 4111 according to the second embodiment of the invention.

To be more specifically the control device 6 performs the above-described frequency variance control and the current variance control by outputting a driving signal to the lighting device 5 in accordance with control program after the start of lighting of the light source lamp 4111 and operates the lighting device 5 as described below.

The inverter 52 adjusts the timing for turning each two switching elements of the inverter 52 ON/OFF by turns and sequentially changes the frequency of the driving current supplied to the light source lamp 4111 as shown in FIG. 4. To be more specifically the inverter 52, as shown in FIG. 4, at first, sets the frequency of the driving current supplied to the light source lamp 4111 to the low frequency, inserts the driving current of the first high-frequency for one period right before the polarity inversion of a waveform of the low frequency driving current at the half of the period of the waveform of the low frequency driving current, and thereafter inserts the second high-frequency driving current for one period. The frequency variance controlling section 61 of the control device 6 makes the inverter 52 repeatedly perform the above-described operation and inserts the driving current of the first high-frequency for one period and the driving current of the second high-frequency for one period right before the polarity inversion of a waveform of the low frequency driving current at each half of the period of the waveform of the low frequency driving current.

The current variance control performed by the current variance controlling section 62 is the same as in the first embodiment. To be more specifically, the duty ratio of the switching element is adjusted by the current variance control of the current variance controlling section 62, and the down chopper 51, as shown in FIG. 4, changes the peak value of the driving current supplied to the light source lamp 4111 for each frequency of the driving current (the low frequency, the first high frequency, and the second high-frequency).

The peak values P1, P2, and P3 of the low frequency driving current, the first high frequency driving current, and the second frequency driving current are, as shown in FIG. 4, set to satisfy the relationship of “P1<P2<P3”.

The above-described second embodiment has the following advantages in addition to the same advantages as the first embodiment.

In the embodiment, since the frequency variance controlling section 61 supplies the first high-frequency driving current and the second high-frequency driving current to the light source lamp 4111 right before the polarity inversion of a waveform of the low frequency driving current at each half period of the waveform of the low frequency driving current, the temperatures of the pair of electrodes 4111A can be uniformized at one moment right before the inversion of the polarity, and the fluctuation of the arc after the inversion of the polarity can be suppressed. Consequently, the advantages of improving the durability of the light source lamp 4111 and suppressing the flickering can be achieved appropriately.

In addition, since the current variance controlling section 62 controls the driving of the lighting device 5 and controls such that the peak value P2 of the waveform of the driving current having the first high frequency is greater than the peak value P1 of the waveform of the driving current having the low frequency and the peak value P3 of the waveform of the driving current having the second high frequency is greater than the peak value P2 of the waveform of the driving current having the first high frequency, a high current flows right before the inversion of the polarity, whereby the temperatures of the pair of electrodes 4111A can be uniformized further right before the inversion of the polarity, and the fluctuation of the arc after the inversion of the polarity can be suppressed further.

The invention is not limited to the embodiments described above, and changes or reformations in the invention within the scope in which the object of the invention can be attained are included in the scope of the invention.

In the first embodiment, the time intervals T1, T2, and T3 are not limited to the time intervals (low frequency time period T1: time period in which the low frequency driving current for one period is inserted, first high frequency time period T2: time period in which the first high frequency driving current four three periods is inserted, and second high frequency time period T3: time period in which the second high frequency driving current for one period is inserted) described in the first embodiment, and other time intervals may be used as the time intervals.

In the first embodiment, the frequency variance control is performed in the order of the first high frequency time interval T2, the low frequency time interval T1, and the second high frequency time interval T3, but the order is not limited to thereto, and any other order may be used. Moreover, the low frequency driving current, the first high frequency driving current, and the second high frequency driving current may be supplied randomly. In this case, the low frequency time interval, the first high frequency time interval, and the second high frequency time interval may be set randomly.

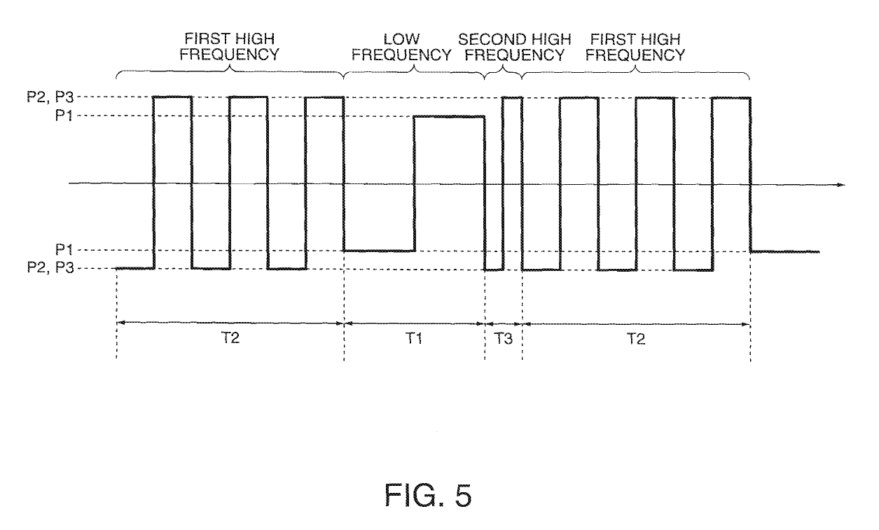

FIGS. 5 to 9 are diagrams showing modified examples of the above-described embodiments. To be more specific, FIGS. 5 to 9 are schematic diagrams showing waveforms of driving currents supplied to the light source lamp from the lighting device.

In the first embodiment, as the current variance control, the peak value P2 of the waveform of the driving current having the first high frequency is greater than the peak value P1 of the waveform of the driving current having the low frequency and the peak value P3 of the waveform of the driving current having the second high frequency is greater than the peak value P2 of the waveform of the driving current having the first high frequency, but the invention is not limited thereto.

For example, as the current variance control, a shown in FIG. 5, the peak value P2 may be greater than the peak value P1 and the peak values P2 and P3 may be the same.

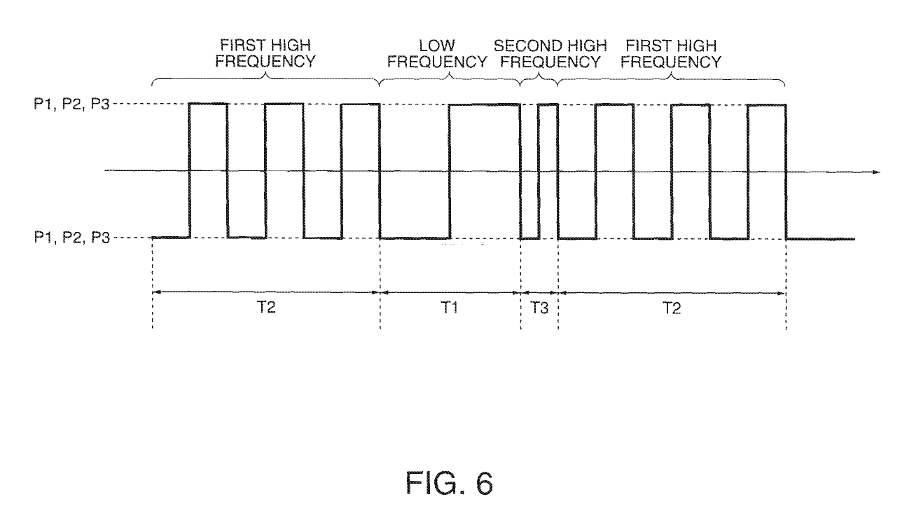

Moreover, the current variance control may not be performed. As shown in FIG. 6, the peak values P1, P2, and P3 may be the same.

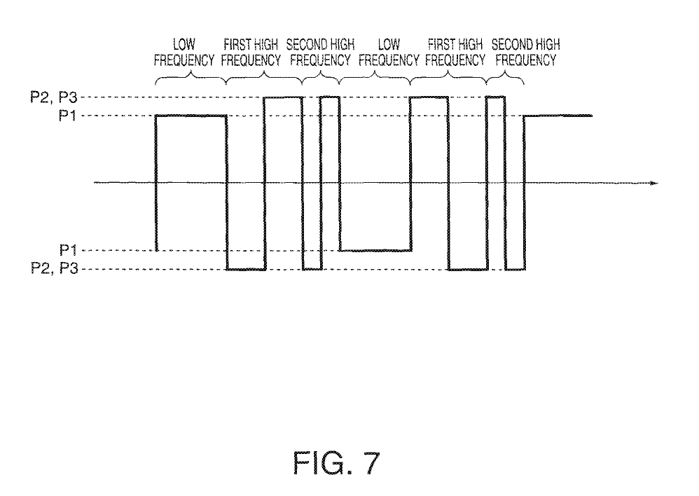

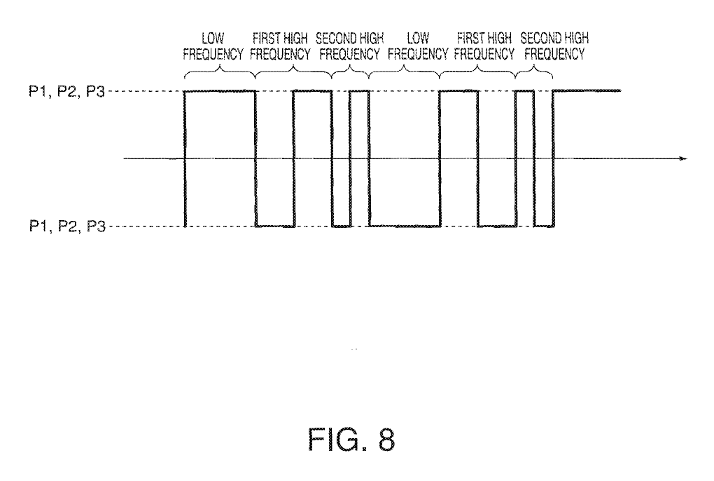

The above-described configuration, as shown in FIGS. 7 and 8, may be applied to the second embodiment.

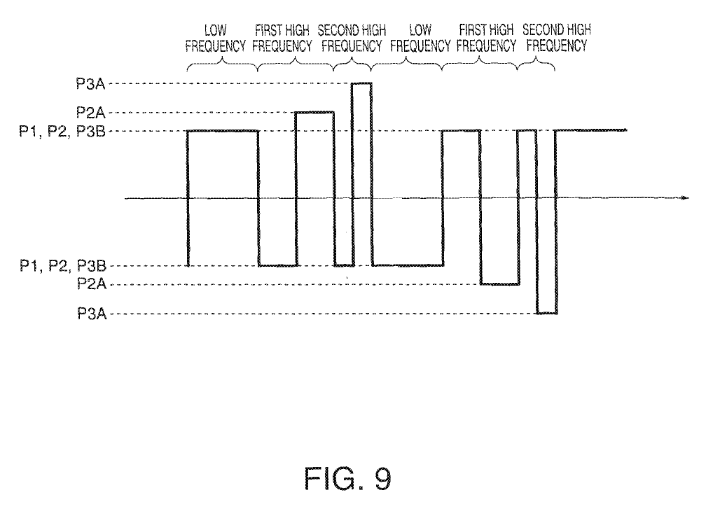

In the second embodiment, as the current variance control, as shown in FIG. 9, only the peak values P2 (P2A) and P3 (P3A) on a side having the same polarity as the low frequency driving current before the inversion of the polarity may be made greater than the peak value P1, and the peak values P2 (P2B) and P3 (P3B) on the side having a polarity opposite to the low frequency driving current before the inversion of the polarity may be equal to the peak value P1.

In each of the embodiments described above, two types of high frequency (the first high frequency and the second high frequency) driving currents are supplied along with the low frequency driving current in the frequency variance control. However, driving currents of two or more types of high frequencies, for example, three types of high frequency driving currents may be supplied.

In each of the embodiments, a rectangular waveform is used as the waveform of the driving current. However, the invention is not limited thereto, and a triangular waveform may be used as the waveform of the driving current.

In each of the embodiments, a three-plate type projector having three liquid crystal panels 451 is used as the projector 1. However, the invention is not limited thereto, and a single plate projector having one liquid crystal panel may be used as the projector. Moreover, a projector having two liquid crystal panels or a projector having four or more liquid crystal panels may be used.

In each of the embodiments, a transmission type liquid crystal panel having a light incident surface and a light emitting surface which are different from each other is used, but a reflection-type liquid crystal panel having a light incident surface and a light emitting surface which are the same may be used.

In each of the embodiments, a liquid crystal panel is used as the optical modulation device, but any optical modulation device other than a liquid crystal display such as a device using a micro mirror may be used as the optical modulation device. In this case, the polarizing plates 452 and 453 in the light flux incident side and the light flux emitting side may be omitted.

In each of the embodiments, front-type projector which performs projection from a side observing a screen is exemplified, but the invention may be applied to a rear-type projector which performs projection from a side opposite to the side observing the screen.

In each of the embodiments, the light source device according to an embodiment of the invention is applied to a projector. However, the invention is not limited thereto and the light source device according to an embodiment of the invention may be applied to any other optical device.

Moreover, the invention is not limited to the preferred embodiments described above. In other words, while the invention has been shown and described mainly for specific embodiments, it will be understood by those skilled in the art that various changes in form, materials, quantities, and details may be made therein without departing from the spirit and scope of the invention.

Accordingly, the description limiting form and materials disclosed above should be considered as an example in descriptive sense only and not for purposes of limitation. Therefore, a member other than a part or the whole of the limit in the form, materials, or the like is within the scope of the invention.

Since a light source device according to an embodiment of the invention can improve the durability of a high-pressure discharge lamp and suppress flickering, the light source device may be used for being built in a projector used for a presentation or a home theatre.

The entire disclosure of Japanese Patent Application No. 2006-204730, filed Jul. 27, 2006 is expressly incorporated by reference herein.

What is claimed is:

1. A light source device comprising:
a high-pressure discharge lamp for performing electric discharge emission between a pair of electrodes;
a lighting device for lighting the high-pressure discharge lamp by supplying a driving current of a predetermined frequency to the high-pressure discharge lamp; and
a control device for controlling the lighting device,
wherein the control device controls the frequency of the driving current supplied to the high-pressure discharge lamp from the lighting device and includes a frequency variance controlling section which supplies a low-frequency driving current having a low frequency and two or more types of high-frequency driving currents having frequencies higher than the low frequency to the high-pressure discharge lamp.

2. The light source device according to claim 1,
wherein the frequency variance controlling section supplies the low-frequency driving current and the two or more high-frequency driving currents to the high-pressure discharge lamp at predetermined time intervals.

3. The light source device according to claim 1,
wherein the frequency variance controlling section supplies a driving current having a first high-frequency to the high-pressure discharge lamp right before the polarity inversion of a waveform of the low frequency driving current at each half period of the waveform of the low frequency driving current and supplies a driving current having a second high-frequency higher than the first high-frequency to the high-pressure discharge lamp.

4. The light source device according to claim 1,
wherein the control device controls the driving current supplied from the lighting device to the high-pressure discharge lamp and includes a current variance controlling section which increases peak values of the waveforms of the two or more types of high-frequency driving currents to be larger than the peak value of the waveform of the low-frequency driving current.

5. The light source device according to claim 1,
wherein the low frequency is less than 60 Hz.

6. A projector comprising:
a light source device;
an optical modulation device for forming an optical image by modulating light beam emitted from the light source device in accordance with image information; and
a projection optical device projecting the optical image formed by the optical modulation device on an enlarged scale,
wherein the light source device is the light source device according to claim 1.

7. The projector according to claim 6,
wherein the frequency variance controlling section supplies the low-frequency driving current and the two or more high-frequency driving currents to the high-pressure discharge lamp at predetermined time intervals.

8. The projector according to claim 6,
wherein the frequency variance controlling section supplies a driving current having a first high-frequency to the high-pressure discharge lamp right before the polarity inversion of a waveform of the low frequency driving current at each half period of the waveform of the low frequency driving current and supplies a driving current having a second high-frequency higher than the first high-frequency to the high-pressure discharge lamp.

9. The projector according to claim 6,
wherein the control device controls the driving current supplied from the lighting device to the high-pressure discharge lamp and includes a current variance controlling section which increases peak values of the waveforms of the two or more types of high-frequency driving currents to be larger than the peak value of the waveform of the low-frequency driving current.

10. The projector according to claim 6,
wherein the low frequency is less than 60 Hz.
